(19) United States
(12) Patent Application Publication
(10) Pub. No.: US 2008/0296941 A1
(43) Pub. Date: Dec. 4, 2008

(54) AIR BAG DEPLOYMENT SYSTEM

(75) Inventors: James Bederka, Northville, MI (US); Scott Lucas, Howell, MI (US); Michael Filipovich, West Bloomfield, MI (US); Jerry Brown, Northville, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/755,142

(22) Filed: May 30, 2007

(51) Int. Cl. B60R 21/20; B60R 21/207

(52) U.S. Cl. 297/216.1; 280/728.1; 29/700

(57) ABSTRACT

An air bag deployment system for use in a vehicle is disclosed have a frame, an air bag, a first deployment chute portion, and a second deployment chute portion. The frame is securable within the vehicle for use therein defining a support structure and a channel therethrough. The air bag is disposed within the support structure of the frame. The air bag deployment mechanism is operatively connected to the air bag. The first deployment chute portion is provided at least partially disposed in and securable adjacent the channel by at least one retainer. The second deployment chute portion at least partially disposed in and securable adjacent the channel by at least one retainer. The first and second deployment chute portions partially support the air bag and assist the air bag to move from a stored position to at least one deployed position when activated by the deployment mechanism.

### BACKGROUND OF THE INVENTION

1. Field of the Invention

Various embodiments of the present invention relate to air bag deployment systems for use in a vehicle.

2. Background Art

To improve vehicle safety, vehicle manufacturers and suppliers generally include air bag assemblies mounted within the vehicle and deployable between an occupant and an adjacent vehicle body structure under impact conditions. The air bag assembly deploys to dampen and distribute an impact load, which reduces occupant injuries resulting from the impact condition.

One type of air bag assembly is located at a visible, discrete location within the vehicle. Deployment of this type of assembly uses technology that is well established for air bags in steering wheels, instrument panels, and doors. Another type of air bag assembly is provided beneath a soft cover, such as on a vehicle seat, and is designed to deploy through the soft cover. With this type of air bag assembly, there are considerably more variables involved in providing consistent air bag deployment and in meeting the desired air bag in-position timing.

A side air bag (SAB) assembly is typically mounted within a vehicle seat and deployable between the occupant and an adjacent vehicle door or vehicle body structure. A SAB assembly may be mounted beneath the vehicle seat cover and padding so that the SAB assembly does not adversely affect seat comfort. The seat cover provides numerous variables affecting air bag deployment.

SAB assemblies typically use a device commonly referred to as a deployment chute or intensifier sleeve that serves to assist the SAB in deploying out of the seat through the cover. A deployment chute or intensifier sleeve is often required because the strength of the front bolster seam of the vehicle seat coupled with the movement and/or elasticity of the seat cover material tend to cause the SAB to become trapped in the seat.

One current design for deployment chutes or intensifier sleeves requires a band of air bag material that nearly covers one hundred percent of the circumference of the interior surface of the seat cover in an attempt to negate cover material stretch. Another current design utilizes a band of material that encompasses one entire side of the seat frame, and attaches to a separate bracket on the rear of the vehicle seat. Either design is less than optimal due to the amount of materials used, the additional bracketry and assembly labor involved.

### SUMMARY OF THE INVENTION

An air bag deployment system for use in a vehicle is provided. The air bag deployment system includes a frame, an air bag, a first deployment chute portion, and a second deployment chute portion. The frame is securable within the vehicle for use therein defining a support structure and a channel therethrough. The air bag is disposed within the support structure of the frame. The air bag deployment mechanism is operatively connected to the air bag. The first deployment chute portion is provided at least partially disposed in and securable adjacent the channel by at least one retainer. The second deployment chute portion at least partially disposed in and securable adjacent the channel by at least one retainer. The first and second deployment chute portions partially support the air bag and assist the air bag to move from a stored position to at least one deployed position when activated by the deployment mechanism.

The above embodiments, and other embodiments, objects, features, and advantages of the present invention are readily apparent from the following detailed description of embodiments of the invention when taken in connection with the accompanying drawings.

### BRIEF DESCRIPTION OF THE DRAWINGS

FIG. 1 is a perspective view of a vehicle seat having an air bag assembly;

FIG. 2 is another perspective view of the vehicle seat of FIG. 1 having an air bag assembly in a deployed position;

FIG. 3 is a perspective view of a seat frame of the vehicle seat as shown in FIG. 1;

FIG. 4 is a cross-sectional view of the vehicle seat of FIG. 1 taken along the line A-A in FIG. 1;

FIG. 5 is a perspective view of deployment chutes of the assembly;

FIG. 6 is a cross-sectional view of another embodiment of the vehicle seat of FIG. 1 taken along the line A-A in FIG. 1;

FIG. 7 is another cross-sectional view of yet another embodiment of the vehicle seat of along the line A-A in FIG. 1;

FIG. 8 is a cross-sectional view of another embodiment of the vehicle seat taken along the line A-A in FIG. 1; and

FIG. 9 is yet another cross-sectional view of another embodiment of the vehicle seat taken along the line A-A in FIG. 1.

### DETAILED DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

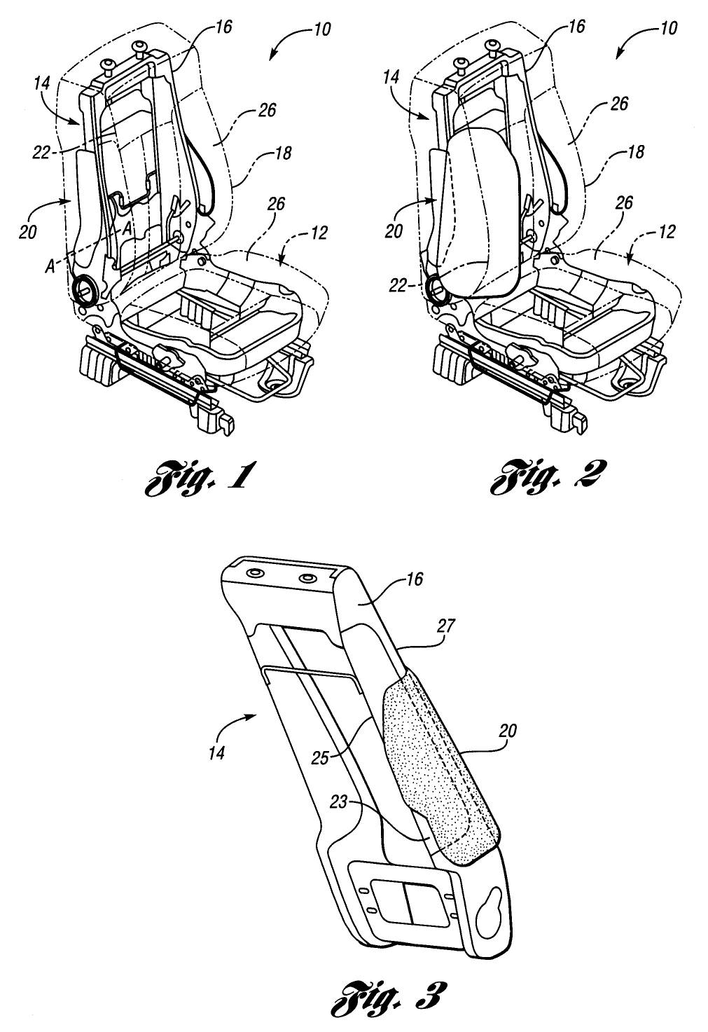

Referring to FIGS. 1 and 2, a vehicle seat is illustrated and referenced generally by numeral 10. The vehicle seat includes a seat bottom 12 secured to a floor of an associated vehicle for receiving an occupant upon the seat bottom 12. A seat back 14 extends from the seat bottom 12 and is secured relative to the seat bottom 12 for supporting a back of the occupant against the seat back 14. The seat back 14 may pivot relative to the seat bottom 12 so that an occupant can select a comfortable riding position while sitting in the vehicle seat 10. The seat back 14 includes a frame 16 that provides structural support for the seat back 14.

A cover 18 may rest on a bolster 26 or multiple bolsters that may be mounted on the frame 16 to support the occupant. As depicted, the cover 18 is made out of a plurality of pieces of a material joined together at a seam 22 or multiple seams. Any suitable cover 18 and bolster may be utilized within the scope of the present invention.

An air bag assembly 20 is mounted to frame 16 by retainers 24 along forward and rear edges of the frame 16. In FIG. 1, the air bag assembly 20 is shown in a stored position while FIG. 2 shows the air bag assembly 20 in a deployed position. An air bag 32 is provided the air bag assembly 20. Upon detection of an impact condition, the air bag 32 is deployed from the stored position to the deployed position through the seam 22 by a deployment mechanism 34 as shown in FIG. 4. In the deployed position, the air bag 32 dampens and distributes an impact load which reduces occupant injuries resulting from the impact condition.

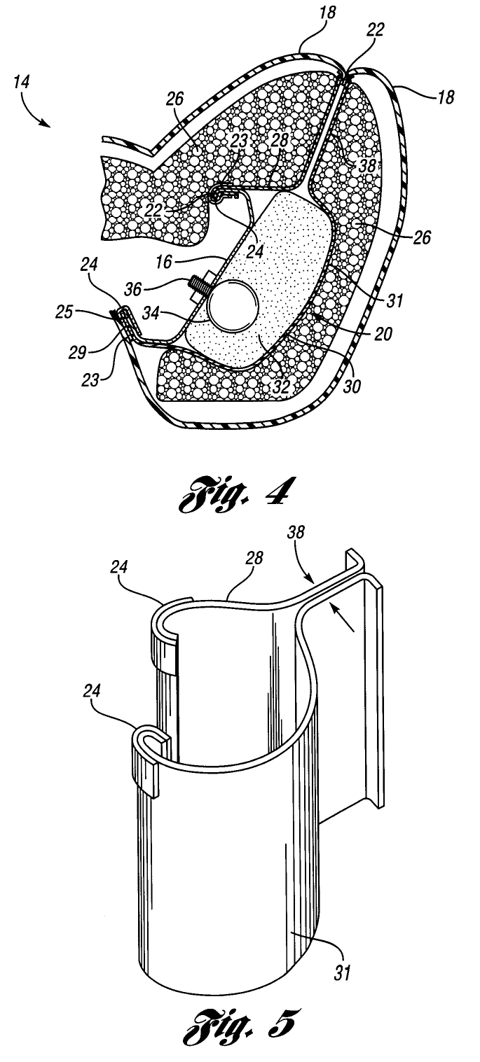

With reference now to FIG. 3, the seat back 14 of FIG. 1 is illustrated from a rear perspective. The air bag assembly 20 is mounted to the frame 16. The frame 16 has an attachment surface 23 which may be generally planar and an opposing rear edge 25 and a forward edge 27.

Referring now to FIG. 4, a portion of the seat back 14 of FIG. 1 is illustrated in cross-section along the line A-A. The frame 16 supports the cover 18 and the bolster 26, as depicted. An air bag deployment system may include at least one sleeve 28 and an air bag assembly 20 as in the depicted embodiment.

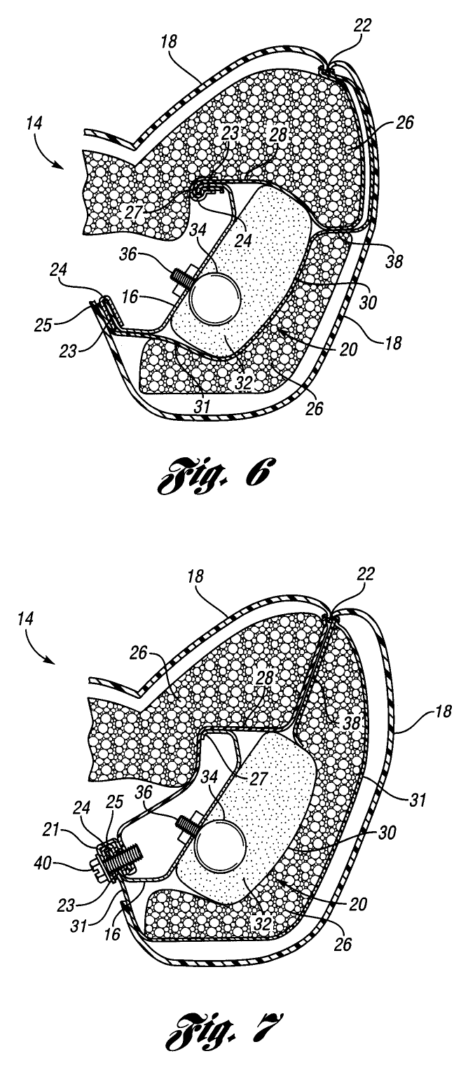

The at least one sleeve 28 may include first and second sleeves 28 and 31 are mounted to the frame 16 at respective first ends and the cover 18 at respective second ends. The sleeves 28 and 31 collectively assist the air bag assembly 20 to deploy out of the seat back 14 through the seam 22 of the cover 18. The sleeves 28 and 31 do not wrap around the entire frame 16 or even one entire side of the frame 16, which decreases the amount of material required to produce the sleeve 16, as illustrated in a perspective view in FIG. 5. The sleeves 28 and 31 may be made of a substantially non-stretchable material having a tensile strength sufficient to withstand the force of the inflating air bag without tearing using a polymeric fabric such as nylon or the like.

In FIG. 4, the sleeves 28 and 31 are mounted to the frame 16 by at least one retainer 24. In one embodiment, the retainers 24 are j-clips which require minimal installation time and are easy to install. It is understood that any configuration or number of retainers may be utilized to secure the air bag assembly 20 to the frame 16.

As illustrated additionally in FIG. 3, the at least one sleeve 28 may be mounted to the frame 16 at a first end at an attachment surface 23. The attachment surface 23 is a portion of the frame 16 which may be located near the rear edge 25 of the frame 16 and near the forward edge 27 of the frame 16. In another embodiment, the attachment surface 23 is located near only the rear edge 25 of the frame 16. In yet another embodiment, the attachment surface 23 is located near only the front edge 27 of the frame 16.

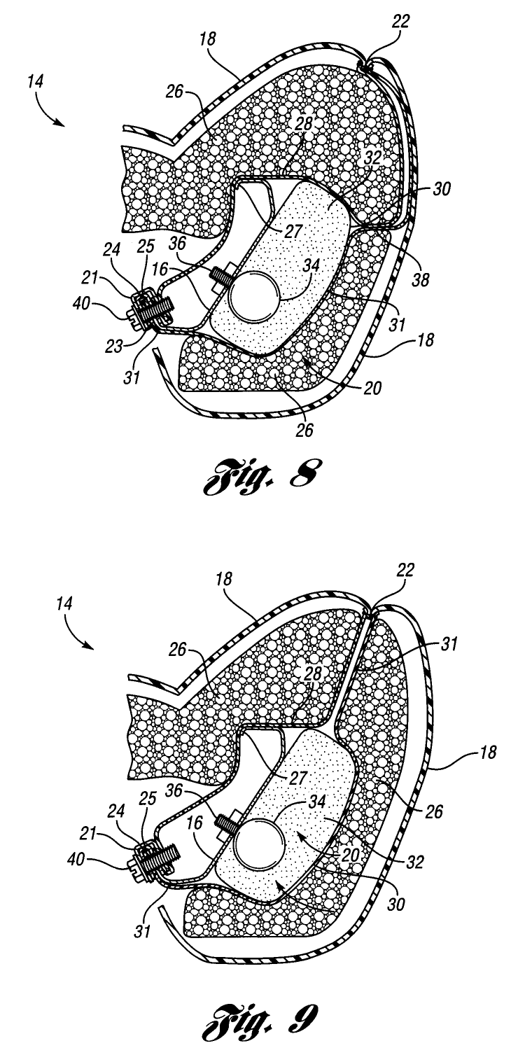

The attachment surface 23 may be generally planar to aid in the retention of at least one retainer 24. To further aid the retention of the retainer 24, the attachment surface 23 may have a recess 29 formed therein. If a recess 29 is provided, assembly of the sleeve 28 to the frame 16 is expedited because the recess 29 acts as a guide for placement of the retainer 24. In another embodiment, the attachment surface 23 and retainer 24 each have a corresponding aperture 29 formed therethrough to receive a fastener, such as a threaded screw, as depicted in FIGS. 7-9.

As illustrated in FIG. 4, the at least one sleeve 28 is attached to the cover 18 at a second end opposite to the first end attached to the frame 16. The sleeve may be sewn to the cover 18. Any suitable attachment to the cover 18 is contemplated within the scope of the present invention.

Between the attachment to the frame 16 and the cover 18, the sleeves 28 and 31 each pass through a channel 38 provided through the bolster 26. In the illustrated embodiment, one sleeve 28 is attached to the forward edge 27 of the frame 16, passes along the bolster 26 through the channel 38 and is attached to the cover 18 at a first side of the channel 38. A second sleeve 31 is attached to the rear edge 25 of the frame 16, passes along the bolster 26 and the air bag assembly 20, through the channel 38, and is attached to the cover 18 at a second side of the channel 38, opposite to the first side of the channel 38. In the depicted embodiment, the design of the first sleeve 28 and the second sleeve 31 reduce the amount of material necessary for the sleeves 28 and 31 and adequately guide the air bag 32 through the channel 38 from a stored position to a deployed position.

The air bag assembly 20 includes an air bag module 30, an air bag 32, an air bag deployment mechanism or inflator 34, and an air bag fastener 36. Any suitable air bag assembly 20, air bag module 30, air bag 32, inflator 34, and air bag fastener 36 are contemplated within the scope of the present invention.

The air bag module 30 is mounted to the frame 16 by the air bag fastener 36. The air bag module 30 houses the air bag 32 and the inflator 34. The inflator 34 deploys the air bag 32 to the deployed position through the channel 38 formed through the bolster 26 and the cover 18.

Referring to FIG. 6, another embodiment of a portion of the seat back 14 of FIG. 1 is illustrated in cross-section along the line A-A. In the illustrated embodiment, a first sleeve 28 is attached to the forward edge 27 of the frame 16, which passes along the bolster 26 through the channel 38. The first sleeve 28 passes between an outside of the bolster 26 and an inside of the cover 18, and is attached to the cover 18 at a first side of the channel 38. A second sleeve 31 is attached to the rear edge 25 of the frame 16 and passes along the bolster 26 and the air bag assembly 20, through the channel 38. The second sleeve 31 passes between the outside of the bolster 26 and the inside of the cover 18, and is attached to the cover 18 at a second side of the channel 38, opposite to the first side of the channel 38. In the embodiment illustrated, the orientation of the first sleeve 28 and the second sleeve 31 reduce the amount of material necessary for the sleeves 28 and 31 and adequately guide the air bag 32 through the channel 38 from a stored position to a deployed position.

In FIG. 7, yet another embodiment of a portion of the seat back 14 of FIG. 1 is illustrated in cross-section along the line A-A. As illustrated, a first sleeve 28 is attached to the rear edge 25 of the frame 16, which passes across to the forward edge 27 of the frame 16 to the bolster 26 through the channel 38. The first sleeve 28 is attached to the cover 18 at a first side of the channel 38. A second sleeve 31 is attached to the rear edge 25 of the frame 16 and passes between the outside of the bolster 26 and the inside of the cover 18, through the channel 38. The second sleeve 31 is attached to the bolster 26 at a second side of the channel 38, opposite to the first side of the channel 38. Since both sleeves 28 and 31 are mounted to the frame 16 at one location, less time is required for the assembly process of the vehicle seat. Also less material is required because of the orientation of the first sleeve 28 and the second sleeve 31.

In the present embodiment, the second sleeve 31 is mounted to the rear edge 25 of the frame 16 by a first retainer 24. The first sleeve 28 is mounted to the rear edge 25 of the frame 16 by a second retainer 21. The second retainer 21 fits over the first retainer 24. In another embodiment, the first retainer 24 fits over the second retainer 21. The first retainer 24 and the second retainer 21 may be any suitable known retainer, such as a j-clip.

A fastener 40 is provided through the frame 16, the sleeves 28 and 31 and the retainers 21 and 24 to further secure the sleeves 28 and 31 to the frame 16. Any suitable fastener 40 is contemplated within the scope of the present invention. For example, a threaded screw 40 may be utilized.

With reference to FIG. 8, another embodiment of a portion of the seat back 14 of FIG. 1 is illustrated in cross-section along the line A-A. In the depicted embodiment, a first sleeve 28 is attached to the rear edge 25 of the frame 16 by a first retainer 24. The first sleeve 28 passes across to the forward edge 27 of the frame 16 to the bolster 26 through the channel 38. The first sleeve 28 passes between an outside of the bolster 26 and an inside of the cover 18, and is attached to the cover 18 at a first side of the channel 38. A second sleeve 31 is attached to the rear edge 25 of the frame 16 by a second retainer 21. The second sleeve 31 passes along the bolster 26 and the air bag assembly 20, through the channel. The second sleeve 31 passes between an outside of the bolster 26 and an inside of the cover 18, and is attached to the cover 18 at a second side of the channel 38, opposite to the first side of the channel 38. The orientation of the first sleeve 28 and the second sleeve 31 reduce the amount of material necessary for the sleeves 28 and 31 and adequately guide the air bag 32 through the channel 38 from a stored position to a deployed position.

Referring now to FIG. 9, yet another embodiment of a portion of the seat back 14 of FIG. 1 is illustrated in cross-section along the line A-A. As illustrated, a first sleeve 28 is attached to the rear edge 25 of the frame 16 by a first retainer 24. The first sleeve 28 passes across to the forward edge 27 of the frame 16 to the bolster 26 through the channel 38. The first sleeve 28 is attached to the cover 18 at a first side of the channel 38. A second sleeve 31 is attached to the rear edge 25 of the frame 16 by a second retainer 21 and passes along the bolster 26 and the air bag assembly 20, through the channel. The second sleeve 31 is attached to the cover 18 at a second side of the channel 38, opposite to the first side of the channel 38. In the embodiment illustrated, the orientation of the first sleeve 28 and the second sleeve 31 reduce the amount of material necessary for the sleeves 28 and 31 and adequately guide the air bag 32 through the channel 38 from a stored position to a deployed position.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. An air bag deployment system for use in a vehicle, the system comprising:
a frame securable within the vehicle for use therein defining a support structure and a channel therethrough;
an air bag disposed within the support structure of the frame;
an air bag deployment mechanism operatively connected to the air bag;
a first deployment chute portion provided at least partially disposed in and securable adjacent the channel by at least one retainer; and
a second deployment chute portion at least partially disposed in and securable adjacent the channel by at least one retainer;
wherein the first and second deployment chute portions partially support the air bag and assist the air bag to move from a stored position to at least one deployed position when activated by the deployment mechanism.

2. The system of claim 1 wherein the at least one retainer comprises a J-clip.

3. The system of claim 1 wherein the frame has at least one recess formed therein to receive with the at least one retainer.

4. The system of claim 1 wherein the first deployment chute portion is fully contained within the support structure and the channel.

5. The system of claim 1 wherein the second deployment chute portion is fully contained within the support structure and the channel.

6. The system of claim 1 wherein the first and second deployment chute portions are formed from a polymeric fabric.

7. The system of claim 1 wherein the at least one retainer is further defined as a first retainer and a second retainer such that the first deployment chute portion is mounted to the frame by the first retainer and the second deployment chute portion is mounted to the frame by the second retainer.

8. The system of claim 1 wherein the frame is provided with at least an attachment surface.

9. The system of claim 8 wherein the attachment surface is generally planar.

10. The system of claim 1 wherein the support structure is formed as a bolster securable to a seat back portion of the frame.

11. The system of claim 10 wherein the channel comprises a seam formed in the bolster.

12. The system of claim 11 wherein the channel is formed by a sewn seam and the first and second deployment chute portions are securable to the seam.

13. A vehicle seat incorporating an air bag deployment system, the seat comprising:
a seat frame having a seat bottom securable within the vehicle for use therein and a seat back connected to the seat bottom, the seat frame having a bolster mounted thereon, the bolster having a channel formed therethough;
an air bag disposed within the bolster of the seat frame;
an air bag deployment mechanism operatively connected to the air bag;
a first deployment chute portion provided at least partially disposed in and securable adjacent the channel by at least one retainer; and
a second deployment chute portion at least partially disposed in and securable adjacent the channel by at least one retainer;
wherein the first and second deployment chute portions partially support the air bag and assist the air bag to move from a stored position to at least one deployed position when activated by the deployment mechanism.

14. The vehicle seat of claim 13 wherein the at least one retainer comprises a J-clip.

15. The vehicle seat of claim 13 wherein the seat frame has at least one recess formed therein to receive with the retainer.

16. The vehicle seat of claim 13 wherein the first and second deployment chute portions are formed from a polymeric fabric.

17. The vehicle seat of claim 13 wherein the at least one retainer is further defined as a first retainer and a second retainer such that the first deployment chute portion is mounted to the frame by the first retainer and the second deployment chute portion is mounted to the frame by the second retainer.

18. The vehicle seat of claim 13 wherein the frame is provided with at least an attachment surface.

19. The vehicle seat of claim 18 wherein the attachment surface is generally planar.

20. A method of assembling an air bag deployment system for use in a vehicle seat, the method comprising:
providing a frame securable within the vehicle for use therein defining a support structure and a channel therethrough;
providing an air bag disposed within the support structure of the frame;
providing air bag deployment mechanism operatively connected to the air bag;
providing a first deployment chute portion provided at least partially disposed in and securable adjacent the channel by at least one retainer; and
providing a second deployment chute portion at least partially disposed in and securable adjacent the channel by at least one retainer;
wherein the first and second deployment chute portions partially support the air bag and assist the air bag to move from a stored position to at least one deployed position when activated by the deployment mechanism.
